(19) United States
(12) Patent Application Publication
(10) Pub. No.: US 2016/0357094 A1
(43) Pub. Date: Dec. 8, 2016

(54) Optics of projecor

(71) Applicant: Fusao Ishii, Pittsburgh, PA (US)

(72) Inventor: Fusao Ishii, Pittsburgh, PA (US)

(21) Appl. No.: 14/756,589

(22) Filed: Sep. 21, 2015

Related U.S. Application Data
(63) Continuation of application No. 62/071,310, filed on Sep. 20, 2014.

(51) Int. Cl. G03B 21/10; G02B 27/42; G03B 21/28; G03B 21/62; G02B 5/02; G02B 3/08; G03B 21/20; G02B 27/48

(52) U.S. Cl. CPC G03B 21/10; G03B 21/2013; G03B 21/2033; G02B 27/425; G02B 27/48; G03B 21/62; G02B 5/0226; G02B 5/0289; G02B 3/08; G03B 21/28; G03B 21/208

(57) ABSTRACT

A projection display system is disclosed including a laser light source, projection lens or mirror, and screen. This invention enables a decorative screen which hides a display and matches near-by furniture. This invention also discloses a tiny cost-effective laser light source for projection displays.

### CROSS REFERENCE TO RELATED APPLICATIONS

This application is a Non-Provisional application of Provisional Applications (62/071,310 on Sep. 20, 2014, 62/177,760 on Mar. 23, 2015 and 62/231,861 on Jul. 18, 2015) and is a Continuation in Part (CIP) of Patent Application PCT/US 14/00135 filed on May 28, 2014 and its Provisional Application 61/855,948 on May 28, 2013, which is also a Continuation in Part of patent application Ser. No. 11/285,881 filed on Nov. 23, 2005 and issued into U.S. Pat. No. 7,595,828.

### TECHNICAL FIELD

This invention relates to a display system for projecting an image. More particularly, this invention provides a projection optics enabling a projection display with laser light sources with substantially simpler manufacturing method and lower cost disclosing a light source through projection screen suitable for laser light sources.

### BACKGROUND ART

Projection display started from a front projector as a movie theatre, wherein a projection display projects images to a screen in almost perpendicular direction. This arrangement requires a large space and also requires a dark room to get high contrast images. Then a rear projection display was invented and gained popularity especially in the U.S. where a large room is available. Compared with a front projector, rear projection displays require much less space and also more importantly delivers higher contrast images. A rear projection display required more depth than LCD. As LCD penetrated into the market, rear projection displays disappeared rapidly because it is bulkier than LCD. However LCD consumes much more power to get same brightness as projectors or CRT TVs. CRT TVs used to consume about 100 W of electricity, but typical LCD TVs consume about 300 W for two reasons. One is that LCD utilizes only 8% of backlight. Over 90% of light is wasted. The second reason is the size of display. The screen size of LCD TVs became much larger than those of CRT TVs. Nevertheless, TVs consume much more electricity than before. 200 W increase per TV translates to the increase of 12 nuclear power generators in US alone, assuming that 60 million TVs are being used simultaneously in the U.S. and 200 W×60M=12 billion Watt. An average nuclear generator is about 1 billion watt or 1 million KW. The shortage of electricity is becoming serious especially in China and Japan, where almost all nuclear generators are non-operating after the Tohoku Earthquake and Tsunami. On the other side, the demand of larger TVs keeps increasing and 4K TVs are gaining popularity, which require even more electricity. There is a tremendous need to reduce the power consumption of TVs and displays. Projection displays consume substantially less electricity and its image size can be even larger than that of LCD. Therefore, projection display is re-addressed to replace large LCDs. The majority of projectors use either Mercury lamp or LED. However laser light sources are much more effective for energy consumption, because “Lumen per Watt” of laser light source is higher than those of the others. Projectors with laser light source will reduce power consumption substantially. There has been a great need for economical laser light sources.

Another reason for projection displays to be re-addressed is “A Hidden Display”. The face of LCD display is very dark and almost black, which people hate to place in a living room or any area visible to people. Therefore a TV is often hidden in a cabinet or placed behind a half-mirror. Projection displays are more suitable for hidden display than LCD as shown in this application.

Because of the bulkiness of rear projection display, front projectors with vertical projection are gaining popularity, which requires much less distance to project, typically less than 2 feet. The contrast ratio of front projector was not as good as that of rear projection display, but it is substantially improved and getting closer to that of rear projection and LCD. On the other hand, the cost of optics for vertical projection is substantially higher than that of regular projector which projects images at a distance, because it requires a large free-form-mirror (free-form means computer generated surface) and a projection screen with much flatter surface. There are needs to reduce the cost of optics for vertical projection displays.

A vertical projection optics, in other words, short throw optics is more sophisticated than those of conventional projectors because of more corrections are required due to its tilted projection angle. For vertical projection, many models are already available in the market since mid-2000s. Some of them use a large free-form-mirror, whose surface is computer generated and not spherical nor cylindrical and numerically controlled machining tools are required to make molds and furthermore the manufacturing requires long press time to cool down mirrors until no further shrinkage of mirror material. Because of expensive mold and long press time of product, these mirrors are very expensive, which is hindering the cost reduction of vertical projection displays. There are tremendous needs to produce vertical projectors economically.

### SUMMARY OF THE INVENTION

The purpose of this invention is to provide a projection display system including a light source through a projection screen suitable for laser light sources and short throw. Compared with conventional projectors with a light source using Mercury lamp or LED, the projection display system with laser light sources differs substantially at every component. This invention covers a structure of laser light source which can be produced substantially smaller than before and also substantially lower cost. This invention also covers an optical lens system for laser light source with lower manufacturing cost. It also covers projection screens to reduce speckle, which is unique to laser light source. It also covers a hidden display screen with a decorative surface matching near-by furniture.

It is an aspect of this invention to create a laser light source suitable for projectors.

It is an aspect of this present invention to reduce the cost of optics for vertical projection as well as improving the quality of images and ease of transportation of large screens. About reducing the cost of free-form-mirrors, it is possible to replace expensive molded plastic mirrors with holographic optical element (HOE) or diffractive optical element (DOE) if light sources are laser which has much narrow bandwidth of spectrum shown in FIG.-5. Conventional projectors use either Mercury lamp or LED which have wider spectrum and have much larger Chroma-aberration and HOE or DOE was not usable for these light sources.

Another aspect of this invention is to increase contrast ratio of projection screen using HOE or DOE as projection screen wherein HOE or DOE has an optically parabolic or elliptic reflective surface so that a projected image from a single projector is projected in parallel toward viewers or to a small area where viewers are located. Ambient light coming from points other than the projection light source is reflected away from the viewers and high contrast image can be seen by the viewers.

Another aspect of this invention is to hide a projection screen with a decorative layer, so that when a display is turned off, viewers will see only the surface of decorative layer and no display is visible to viewers, but when the display is turned on, images are visible to viewers. This projection screen will provide a perfectly hidden display with any decorative patterns.

Another aspect of this invention is to reduce the speckle (which means the non-uniformity of brightness distribution of image) coming from laser light source. It was found that the interference is taking place at a reflective surface of the screen wherein the phase of reflected light is slightly different each other in a small area and multiple diffusion at a screen will reduce the speckle of image dramatically.

Another Aspect of this invention is to improve the flatness of projection screen. It is often experienced that a projection screen hung from a ceiling or a hook is not flat and images are often distorted. To provide the least distorted images to viewers requires to keep projection screens flat. Vertical Throw or Short Throw projectors, meaning short distance between a projector and a screen, are much more sensitive to the flatness of screens and even a small non-flatness of screen will cause a large distortion of image. Many projection screens are often attached to a rigid plate, but is not easy to handle nor to transport. A flexible screen able to roll up is much more desirable, but there were no good ways to keep the flatness of projection screen at viewers locations. This invention provides a set of frames to ensure the flatness of screen and easy to assemble at viewer's sites.

Another aspect of this invention is to enable viewers of the decorative screen to communicate with the system with a touch screen.

Another aspect of this invention is to enable viewers of the decorative screen to communicate with the system with WiFi.

### BRIEF EXPLANATION OF DRAWINGS

FIG.-1 shows a prior art of front projection screen.

FIG.-2 shows a prior art of rear projection screen.

FIG.-3 shows a prior art of rear projection screen with a detailed drawing. 73 is a Fresnel lens and 74 is a lenticular.

FIG.-4 shows a prior art of speckle reducer with a laser light source. 44 is a laser diode. 41 is a rotating disc with a diffuser.

FIG.-5 shows a prior art of speckle reducer with optical fibers. 11 through 13 are laser diodes. 21 through 23 are optical fibers for each color laser beam. 27 is an integrator to combine three color laser beams into one.

FIG.-6 shows a prior art of decorative screen of display and FIG.-7 shows another example how to create hologram wherein the photopolymer is exposed with laser light and the exposed patterns will be fixed chemically.

FIG.-8 shows a prior art of vertical throw screen with high contrast.

FIG.-9 is void.

FIG.-10 shows an example of this invention wherein reflective HOE or DOE (1002 and 1004) are used to replace an expensive free-form-mirror

FIG.-11 shows another example of this invention wherein both transmissive and reflective HOEs or DOEs (1102 and 1104) are used to replace expensive free-form-mirrors.

FIG.-12 shows an example of wavelength spectrum from laser light sources, which are substantially narrower than those of LED.

FIG.-13 shows an example of this invention wherein HOE is created by exposing and fixing photo-sensitive material (1301) such as photo-polymer using a free-form-mirror (1305) and a collimated light beam (1303).

FIG.-14 shows an example of this invention wherein HOE is created by exposing and fixing photo-sensitive material (1401) using Galvano-mirrors (1421 and 1422), so that the angle of incident laser beams can be controlled arbitrarily.

FIG.-15 shows an example of invention wherein HOE is created by exposing and fixing photo-sensitive material (1501) using Galvano-mirrors (1522) and a mirror with an elliptic surface (1523), so that the landing location of laser beam stays same, although the angle of incident laser beam can be controlled arbitrarily.

FIG.-16 shows an example of this invention wherein transmissive HOE is created by exposing and fixing photo-sensitive material (1601) using Galvano-mirrors (1622) and a mirror with an elliptic surface (1623), so that the landing location of laser beam stays same, although the angle of incident laser beam can be controlled arbitrarily.

FIG.-17 shows an example of this invention of laser light source.

FIG.-18 shows another example of this invention of laser light source.

FIG.-19 was void.

FIG.-20 shows an example of this invention wherein a projection screen (2001) is made flat by applying tension vertically with a pair of frames (2002) and bow (2003L and 2003R).

FIG.-21 shows another example of this invention wherein a projection screen (2101) is made flat by applying tension vertically with a pair of frames (2002) and bow (2003L and 2003R) located in intermediate locations of frames or close to Bessel points, so that the load to the frames are distributed more evenly.

FIG.-22 through 24 are void.

FIG.-25 shows an example of speckle created by a projector with laser light source.

FIG.-26 shows an example of this invention wherein a projection screen (2603) is capable to reduce speckle with at least two layers of diffuser (2604 and 2605).

FIG.-27 shows another example of this invention wherein a projection screen (2603) is capable to reduce speckle with at least two diffusing surfaces with sandy or embossed surfaces (2704 and 2706).

FIG.-28 shows another example of this invention wherein a projection screen (2803) is capable to reduce speckle with 4 diffusing surfaces with sandy or embossed surfaces (2803 through 2806).

FIG.-29 shows another example of this invention wherein a projection Fresnel screen (2903) is capable to reduce speckle with at least two diffusing lasers with particles (2904 and 2905) optically different from base substrates (2906).

FIG.-30 shows another example of this invention wherein a projection Fresnel screen (3003) is capable to diffuse the incident light with a diffusing laser having particles (3004) optically different from base substrates (3005).

FIG.-31 shows another example of this invention wherein a projection Fresnel screen (3103) is capable to reduce speckle by diffusing the incident light with at least two diffusing lasers having particles (3104) optically different from base substrates (3105).

FIG.-32 shows another example of this invention wherein a projection lenticular screen (3204) is capable to reduce speckle by diffusing the incident light with embedded particles optically different from base substrates.

FIG.-33 shows another example of this invention wherein a projection lenticular screen (3304) is capable to reduce speckle with coated diffusing material (3309 and 3311) on the surface of Fresnel lens.

FIG.-34 shows another example of this invention wherein a projection lenticular screen (3403) is capable to reduce speckle with coated diffusing material (3411) within grooves or holes on the surface.

FIG.-35 shows another example of this invention wherein a reflective projection Fresnel screen (3503) is capable to reduce speckle with coated diffusing material (3504).

FIG.-36 shows another example of this invention wherein a reflective projection Fresnel screen (3603) is capable to reduce speckle with two layers (3604 and 3609) of coated diffusing material.

FIG.-37 shows another example of this invention wherein a reflective projection Fresnel screen (3703) is capable to reduce speckle with two flat layers (3704 and 3705) of coated diffusing material.

FIG.-38 shows another example of this invention wherein a reflective projection Fresnel screen (3803) is capable to reduce speckle with four coarse surfaces (3804, 3805, 3806 and 3810).

FIG.-39 shows another example of this invention wherein a reflective projection Fresnel screen (3903) is capable to diffuse light with a coarse surface (3904) on the surface of Fresnel grooves.

FIG.-40 shows an example of projected image wherein speckle is very visible with a single diffusing layer.

FIG.-41 shows an example of projected image wherein speckle is not visible with multiple diffusing layers.

FIG.-42 shows an example of enlarged image of coarse surface.

FIG.-43 shows an example of enlarged image of fine embossed surface. This surface also contributes to reduce speckle.

FIG.-44 through 50 are void.

FIG.-51 shows an example of decorative display screen with a pattern such as wood.

FIG.-52 shows an example of projected image from the backside through a half-transparent decorative screen. The brightness is low and the contrast is very poor.

FIG.-53 shows an example of this invention wherein a decorative transmissive projection screen (5301) is capable to show high brightness and high contrast image (5302).

FIG.-54 shows an example of this invention wherein a decorative transmissive projection screen (5401) is capable to show high brightness and high contrast image with holes (5402).

FIG.-55 shows an example of this invention wherein an incident light (5501) is focused by micro-lens-array or lenticular (5502) onto holes or transparent spots (5506), so that the majority of the incident light will be outputted.

FIG.-56 shows an example of the surface of micro-lens-array.

FIG.-57 shows an example of this invention wherein an incident light (5701) is collimated by a Fresnel lens (5702) and focused by micro-lens-array or lenticular (5704) onto holes or transparent spots (5507), so that the outgoing light will be transmitted substantially Parallel toward viewers.

FIG.-58 shows an example of this invention wherein an incident light (5801) is collimated and focused to each hole (5806) by HOE or DOE (5802), which functions as both collimator and micro-lens-array.

FIG.-59 shows an example of this invention showing a manufacturing method wherein a photo-resist layer is coated (5901) and a collimated light is projected from the other side through holes or transparent spots (5902) so that only the photo-resist in the area around the holes will be exposed and creates convex micro-lens array over the holes after the development of the photo-resist.

FIG.-60 shows an example of this invention showing a manufacturing method wherein an object light (6001) is focused to each hole (6006) and a reference light (6003) coherent to the object light exposes the area exposed by the object light and repeat for each hole.

FIG.-61 shows an example of the measurement of human sight. 1 minute ( 1/60 of 1 degree) of viewing angle corresponds to 1.0 eye-sight or 20/20 vision acuity. If a person can discriminate only 2 minutes of angle, the eye-sight is 0.5 (inverse of viewing angle in minute is the definition of eye-sight) or 20/40 of vision acuity.

FIG.-62 shows a test pattern to measure the sensitivity of human eye to relative brightness.

FIG.-63 shows a measurement result of human eye to relative brightness.

FIG.-64A shows an example of video image at dark video signal without compensation.

FIG.-64B shows an example of video image at bright video signal without compensation.

FIG.-65A shows an example of this invention wherein to hide a decorative pattern by compensating with video signal applying opposite brightness to the decorative pattern at a dark image.

FIG.-65B shows an example of this invention wherein to hide a decorative pattern by compensating with video signal applying opposite brightness to the decorative pattern at a bright image.

### DESCRIPTION OF PREFERRED EMBODIMENTS

FIG.-17 illustrates an example of the embodiment of this invention to make a laser light source suitable for projection displays, wherein laser diodes (1701 through 1705) are placed and fixed with solder or inorganic adhesive on a substrate (1706) and DOE or HOE (1708) is placed in front of the laser diodes and the DOE (or HOE) focuses the laser beams for the diodes to an optical fiber (1710) to integrate multiple laser beams into a single beam.

FIG.-18 illustrates another example of the embodiment of this invention to make a laser light source suitable for projection displays with an optical fiber having a funnel shaped edge so that it will provide more tolerance for misalignment.

FIG.-10 illustrates an example of the embodiment of this invention to make a projection optics system, wherein 1) a reflective SLM(1002) is exposed by laser beams(1011) and projected in a tilted direction substantially away from the normal (perpendicular) direction of the SLM surface and 2) the laser beams from the SLM(1002) are incident to a hologram (1004) which has reflecting and magnifying capability. In FIG.-10, 1001 is a screen for vertical projection. 1002 is a reflective SLM, 1003 is a laser light source containing three colors of laser diodes. 1010 is a collimation lens. 1011 is a collimated beam of light. 1012 is outgoing light beams reflected by the SLM. 1004 is a hologram reflecting and magnifying the beams (1012) to 1013 and toward the screen (1001). 1005 is a reflected light beam by the screen (1001) toward the viewer (1008). Conventional technology uses expensive free-form-mirror at 1004 and this embodiment will decrease the cost of optical system.

FIG.-11 illustrates an example of the embodiment of this invention, wherein 1) a transmissive SLM(1102) is exposed by laser beams(1111) and the outgoing light from the SLM is bent by a hologram and projected in a tilted direction substantially away from the normal (perpendicular) direction of the SLM surface and 2) the laser beams from the SLM(1102) are incident to a hologram (1104) which has reflecting and magnifying capability. In FIG.-11, 1101 is a screen for vertical projection. 1102 is a transmissive SLM, 1103 is a laser light source containing three colors of laser diodes. 1110 is a collimation lens. 1111 is a collimated beam of light. 1112 is outgoing light beams in a tilted direction bent by a hologram (1109). 1104 is a hologram reflecting and magnifying the beams (1112) to 1113 and toward the screen (1101). 1105 is a reflected light beam by the screen (1101) toward the viewer (1108).

FIG.-13 illustrates an example of the embodiment of this invention, wherein 1) a photopolymer screen is exposed by coherent laser beams whose incident directions are created by lens (1304) and a mirror (1305). FIG.-13 shows how to create hologram. Photopolymer (1301) is exposed with laser light and the exposed patterns will be fixed chemically. The exposed patterns with many streaks will reflect incoming light as designed directions. 1314 through 1316 are laser light sources. 1313 is a shutter for the laser. 1320 is a mirror. 1317 and 1318 are dichroic mirrors. 1319 is a beam splitter. 1312 and 1309 are mirrors. 1308 is a lens and 1304 is a collimation lens. 1303 is the first light beams to expose the photopolymer (1301). 1310 is the second beam which is coherent to the first beam and is reflected by a mirror (1307) and expanded by a lens (13013) and reflected by a curved mirror (1305). The reflected light (1302) is projected toward the photopolymer (1301).

FIG.-14 illustrates an example of the embodiment of this invention, wherein 1) a photopolymer screen is exposed by laser beams whose incident directions are determined by rotating mirrors (1421 and 1422) and moving photopolymer screen (1401). FIG.-14 shows another example how to create hologram. Photopolymer (1401) is exposed with laser light and the exposed patterns will be fixed chemically. The exposed patterns with many streaks will reflect incoming light as designed directions. 1414 through 1416 are laser light sources. 1413 is a shutter. 1420 is a mirror. 1417 and 1418 are dichroic mirrors. 1419 is a beam splitter. 1410 is the first beam which is coherent to the second beam(1403) and is reflected by a mirror (1421) to the photopolymer The reflected light (1402) is projected toward the photopolymer (1401). 1402 and 1403 are coherent and create interference patterns of streaks. The photopolymer moves and the mirrors (1421 and 1422) rotate so that the entire area can be exposed in the designed directions of laser beams.

FIG.-15 illustrates an example of the embodiment of this invention, wherein 1) a photopolymer screen is exposed by rotating mirrors (1521 and 1522). FIG.-15 shows another example how to create hologram. Photopolymer (1501) is exposed with laser light and the exposed patterns will be fixed chemically. The exposed patterns with many streaks will reflect incoming light as designed directions. 1514 through 1516 are laser light sources. 1513 is a shutter. 1520 is a mirror. 1517 and 1518 are dichroic mirrors. 1519 is a beam splitter. 1510 is the first beam which is coherent to the second beam(1503) and is reflected by a mirror (1521) to the photopolymer The reflected light (1502) is projected toward the photopolymer (1501). 1502 and 1503 are coherent and create interference patterns of streaks. The photopolymer (1501) stays, but the mirrors (1521 and 1522) move and rotate so that the entire area can be exposed in the designed directions of laser beams.

FIG.-16 illustrates an example of the embodiment of this invention, wherein 1) a photopolymer is exposed by rotating mirrors (1631 and 1632) from the same side. FIG.-16 shows another example how to create hologram. Photopolymer (1601) is exposed with laser light and the exposed patterns will be fixed chemically. The exposed patterns with many streaks will reflect incoming light as designed directions. 1614 through 1616 are laser light sources. 1613 is a shutter. 1620 is a mirror. 1617 and 1618 are dichroic mirrors. 16116 is a beam splitter. 1610 is the first beam which is coherent to the second beam (1603) and is reflected by a mirror (1621) to the photopolymer. The reflected light (1602) is projected toward the photopolymer (1601). 1602 and 1603 are coherent and create interference patterns of streaks. The photopolymer moves and the mirrors (1621 and 1622) rotate so that the entire area can be exposed in the designed directions of laser beams.

FIG.-20 illustrates an example of the embodiment of this invention, wherein 1) tension is applied to a projection screen by frames (2002 and 2004) with protrusions (2008 and 2009) to hold the screen at the holes (2008 and 2009) and the arms (2003 and 2004) to provide tension to the screen with bending structure as a bow. The locations of arms are at the edges with the bending direction to outside. FIG.-20 shows another example of this invention. This screen (2001) can be rolled into a small case and so can the frames(2002 and 2004) and the arms (2003L and 2003R). These can be in a box and transferred much more easily than a screen wherein a film of screen is glued to a thick plate and the entire screen has to be packed in a heavy duty box, often wood box, and have to be carried by a forklift. This invention enables to pack a screen, frames and arms in a small box and assembled in the final consumer's home. The screen has holes (shown at 2008) and the frames have protrusions and these holes are hooked by the protrusions. The screen can be stretched by the arms which are bent as a bow and providing tension to the screen. A vertical tension screen is the invention of this application. 2002 and 2004 can be slightly curved so that the central portions of frames can provide more tension. In FIG.-20, the arms are bent toward right and left.

FIG.-21 illustrates an example of the embodiment of this invention, wherein 1) tension is applied to a projection screen by frames (2102 and 2104) with protrusions (2108 and 2109) to hold the screen at the holes (2108 and 2109) and the arms (2103 and 2104) to provide tension to the screen with bending structure as a bow. The locations of arms are at intermediate areas with the bending direction away from the screen. FIG.-21 shows another example of this invention. The structure is similar to FIG.-10 except the location of arms and the direction of bending. The arms (2103L and 2103R) are located intermediate area of frames so that the distribution of tension to the screen can be more even.

FIG.-26 shows an example of the embodiments of this invention of speckle reduction projection screen. An incident light (2602) from a projector enters a transparent substrate of diffuser (2603). The light is scattered in the first diffusion layer (2604) by diffusion particles whose refractive index is different from the binder (2606) so that the light beams are refracted. The scattered light is scattered again in the second diffusion layer (2605). The coherence of outgoing light (2607) is significantly reduced by the multiple scattering. The example in FIG.-26 has two diffusion layers.

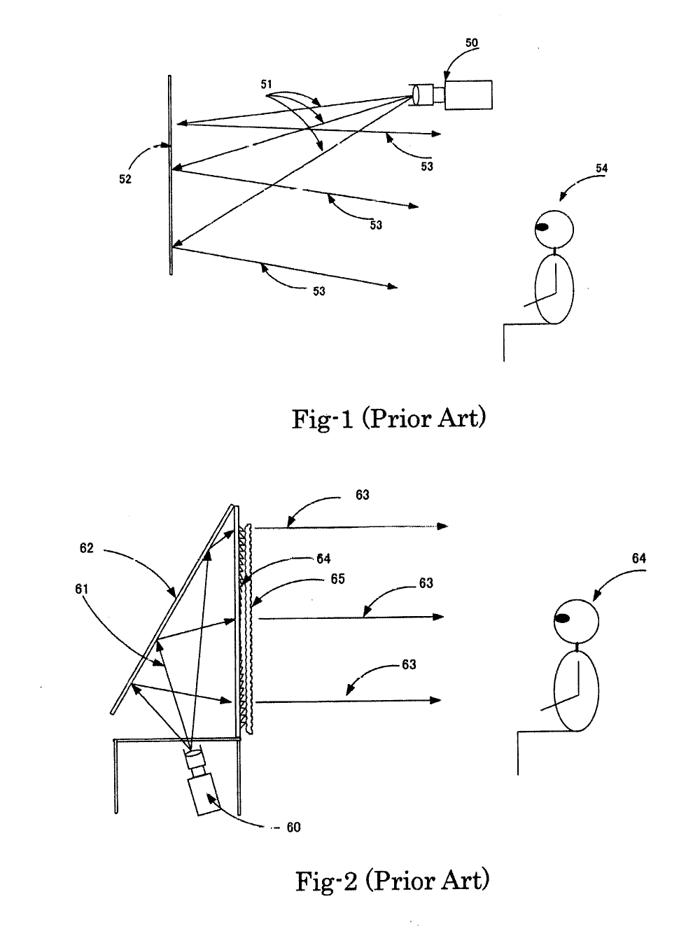

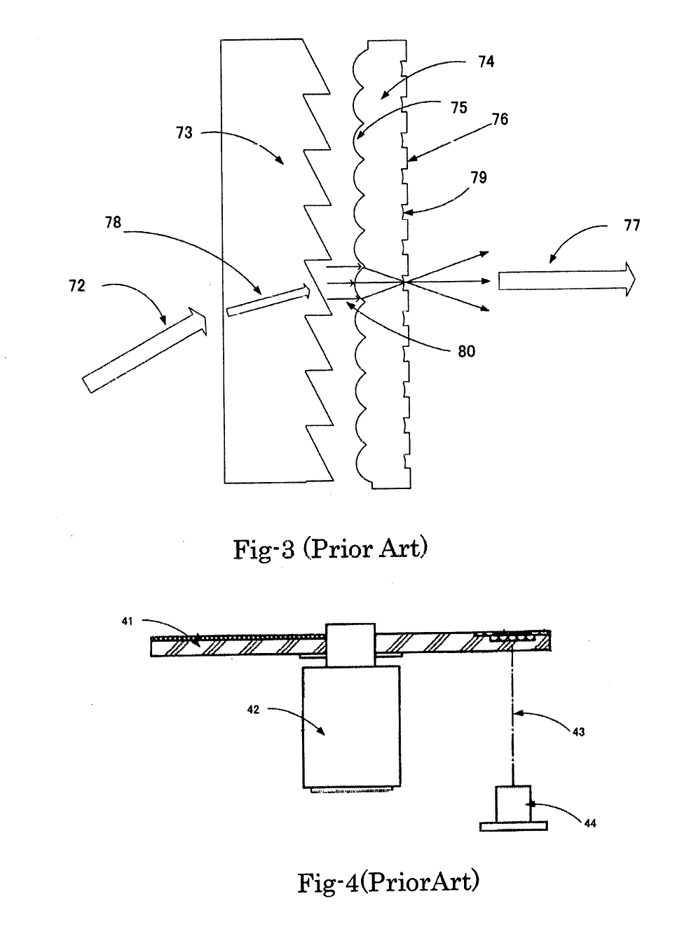

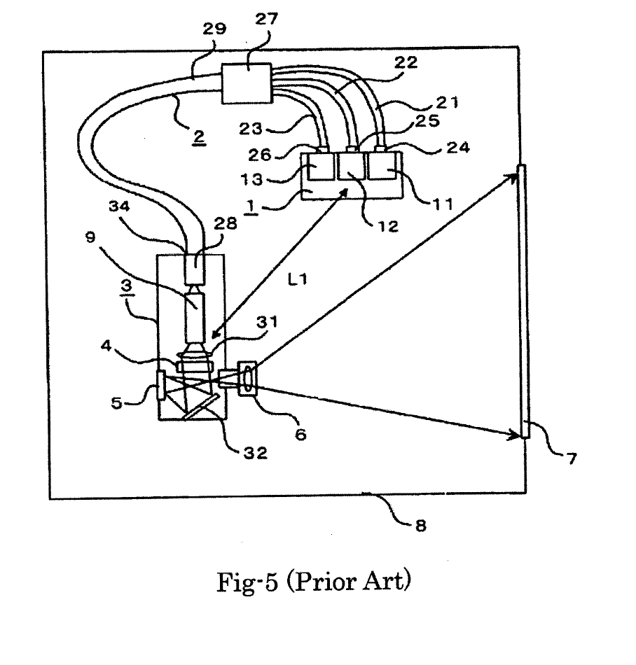

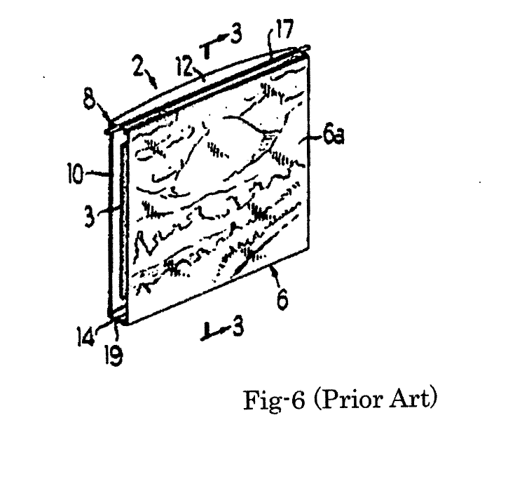

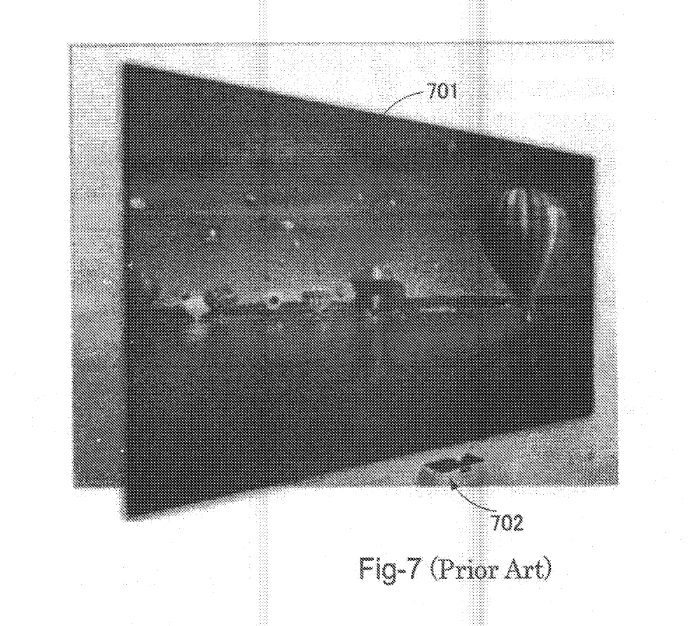

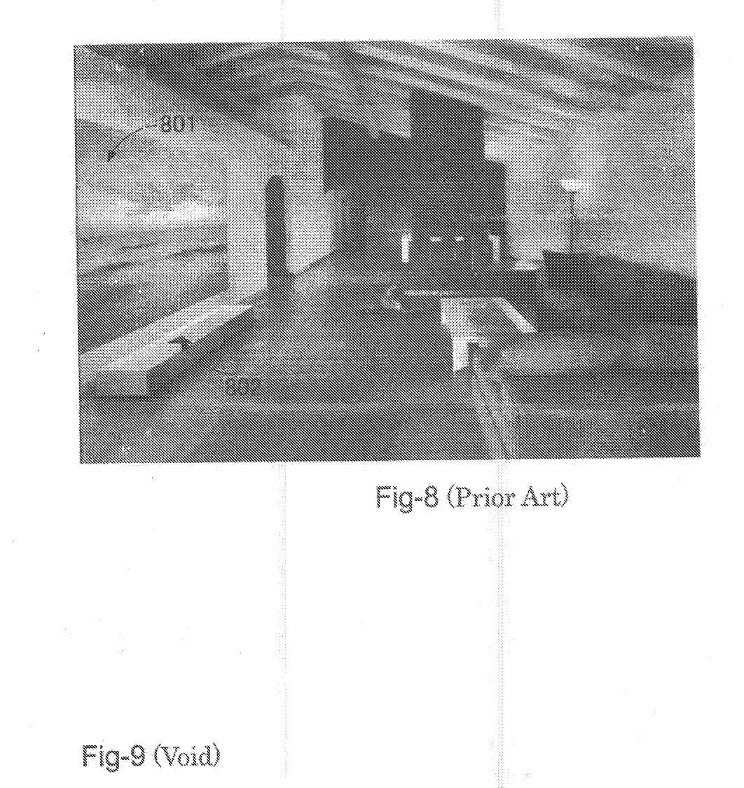

FIG.-8 shows an example of the embodiments of this invention of speckle reduction projection screen. An incident light (2702) from a projector enters a transparent substrate of diffuser (2703). The light is scattered in the first diffusion layer (2704) having rough surface with substantially random 3D structures. The scattered light is scattered again in the second diffusion layer (2705). The coherence of outgoing light (2707) is significantly reduced by the multiple scattering. The example in FIG. 8 has two diffusion layers.

FIG.-28 shows an example of the embodiments of this invention of speckle reduction projection screen. An incident light (2802) enters a Fresnel lens (2803) for collimation. The collimated light (2809) is scattered by the first diffusion layer (2804) and the second diffusion layer (2806). The coherence of the outgoing light (2807) is substantially reduced.

FIG.-29 shows an example of the embodiments of this invention of speckle reduction projection screen. An incident light (2902) enters a Fresnel lens (2903) for collimation. The collimated light (2909) is scattered by the first diffusion layer (2904) and the second diffusion layer (2906). The coherence of the outgoing light (2907) is substantially reduced.

FIG.-30 shows an example of the embodiments of this invention of speckle reduction projection screen, wherein a diffusion layer with diffusion particles (3004) and binder (3005) is coated conformally on the grooves of Fresnel lens. 3002 is an incident light. 3008 is the light which entered the substrate of Fresnel lens (3003). 3004 is a diffusion layer with diffusion particles. 3006 is scattered light by the diffuser (3004).

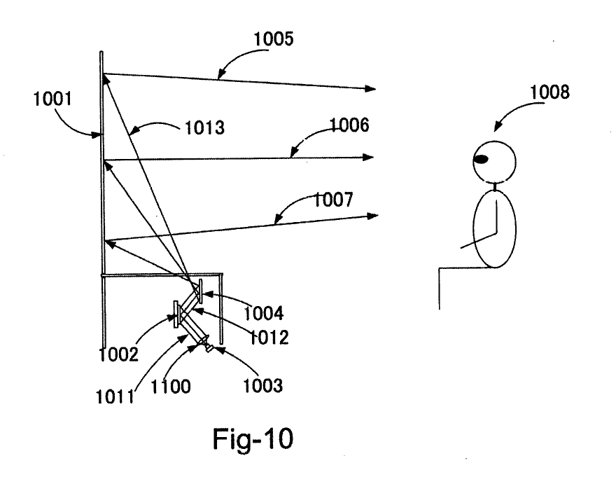

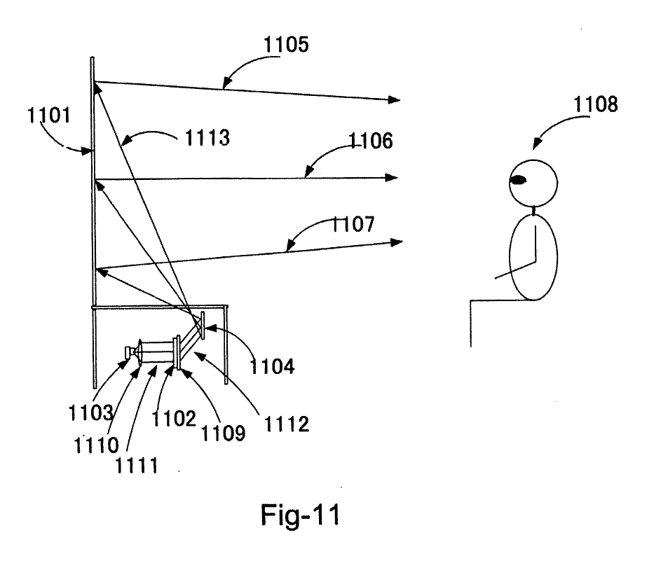

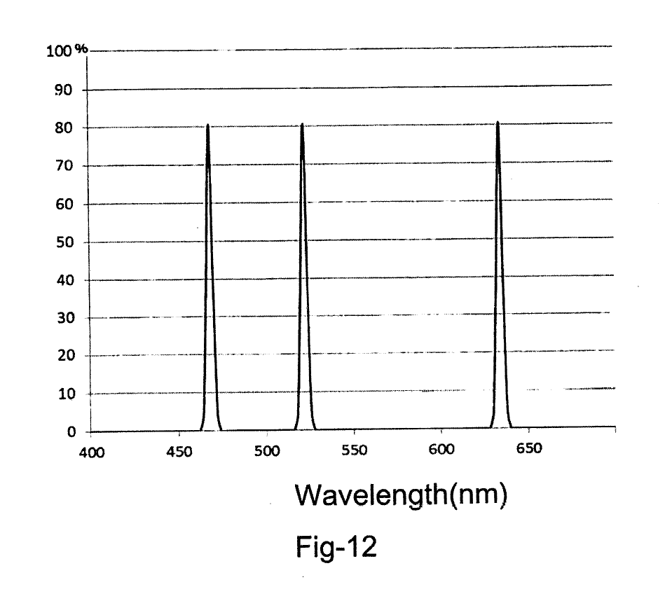

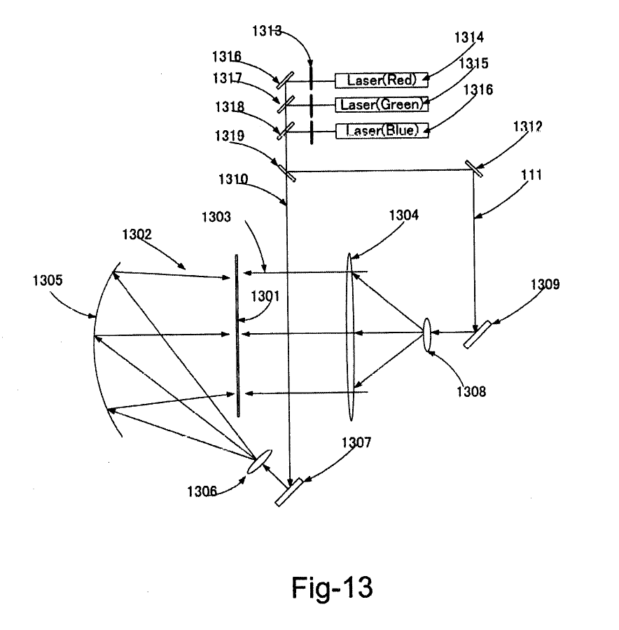

FIG. 12 shows an example of the embodiments of this invention of speckle reduction projection screen, wherein diffusion layers (3104 and 3106) are coated flat on the grooves of Fresnel lens.

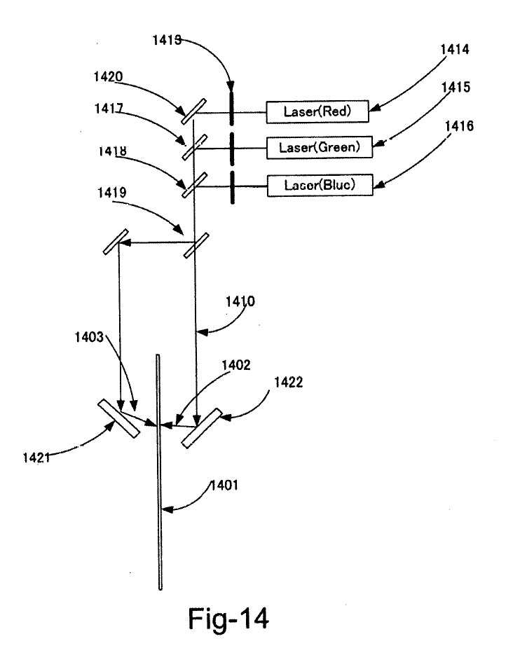

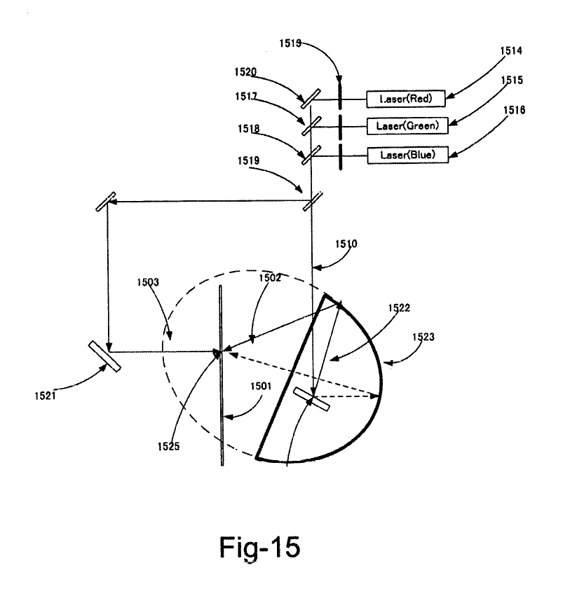

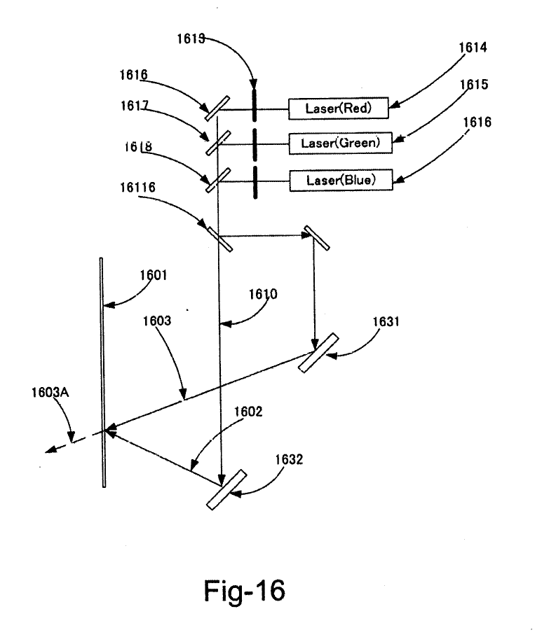

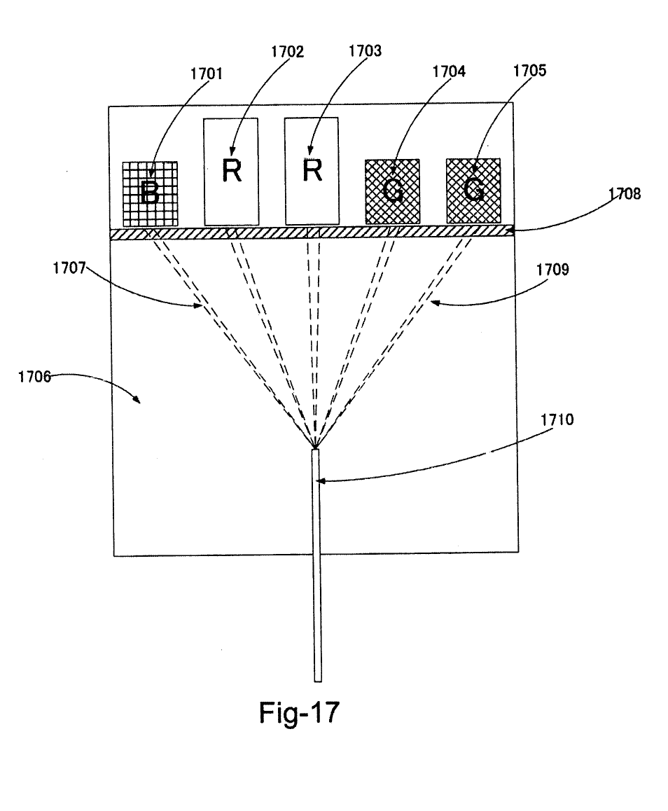

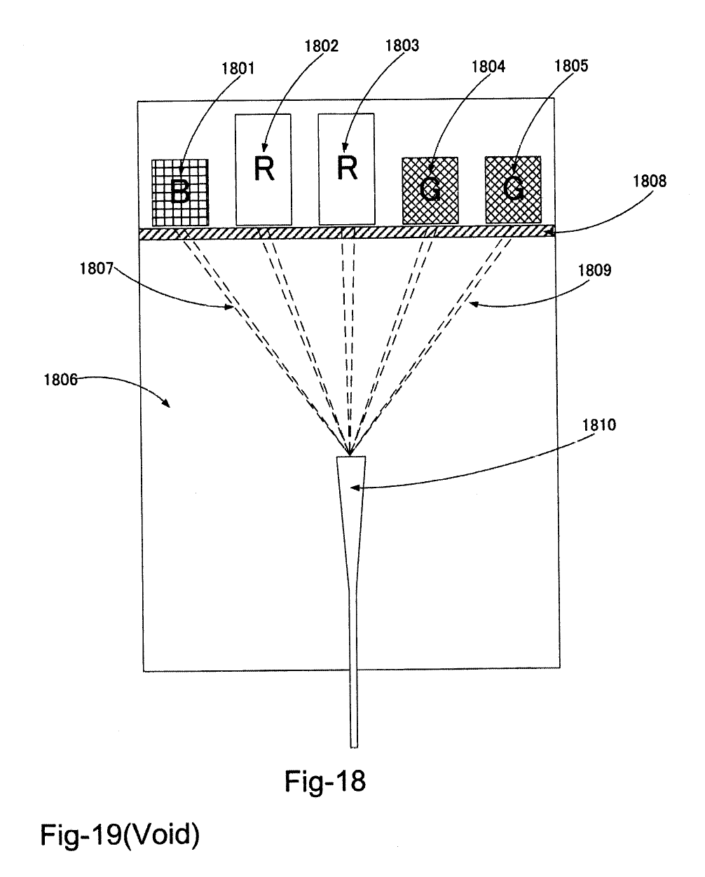

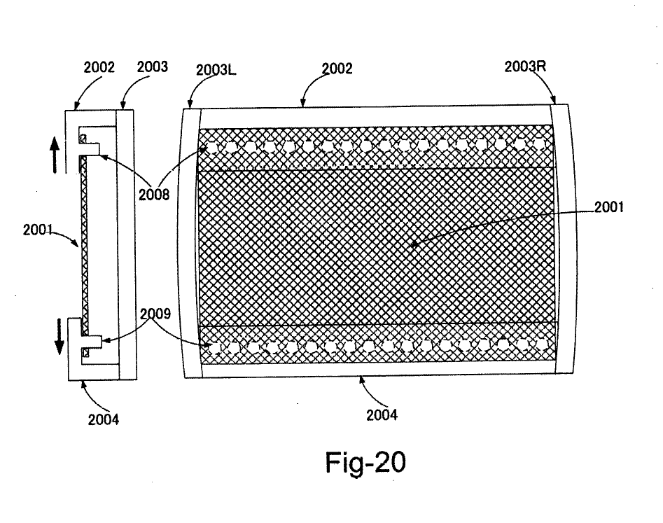

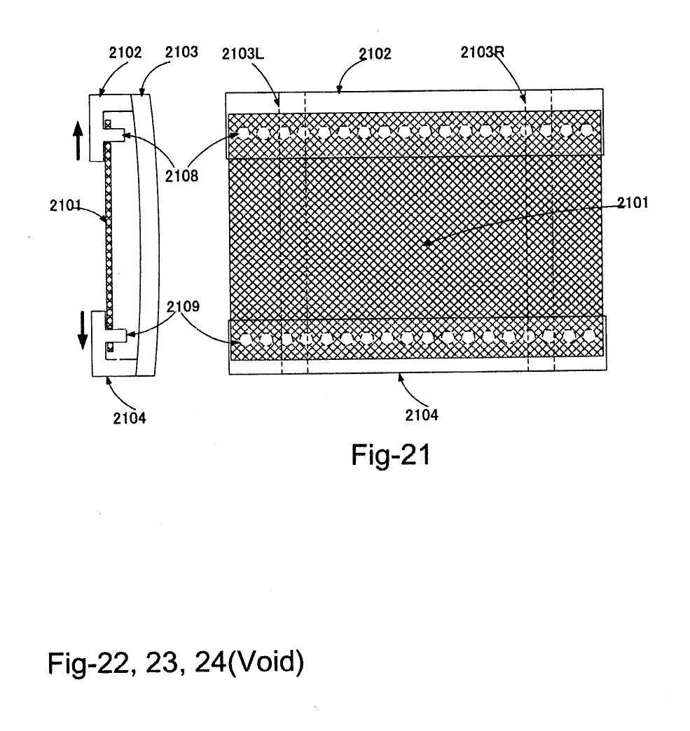

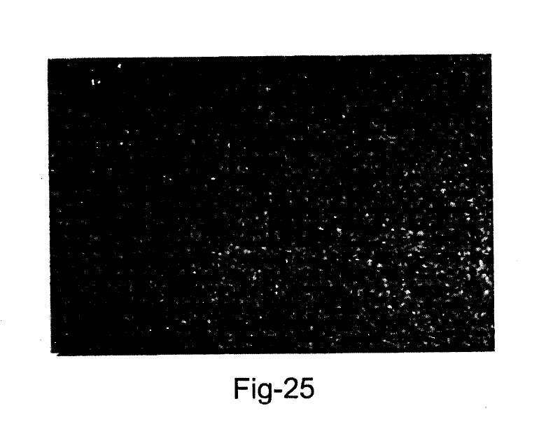

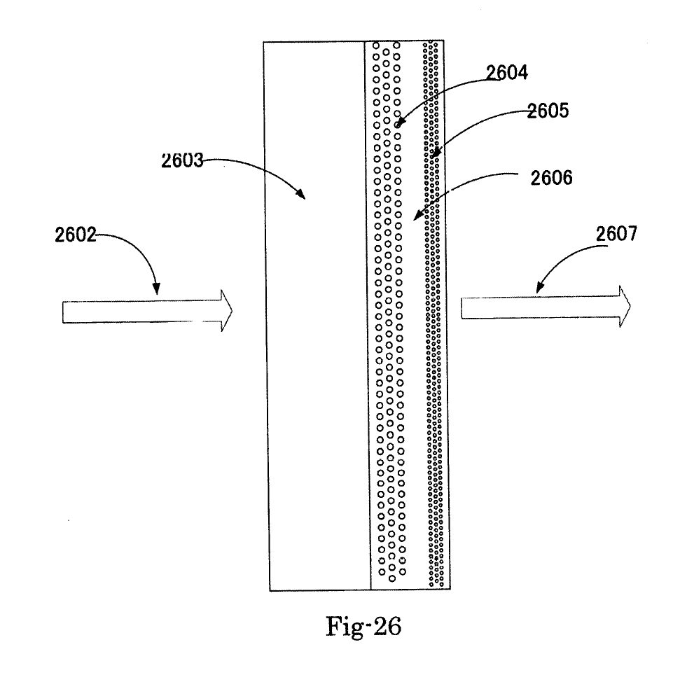

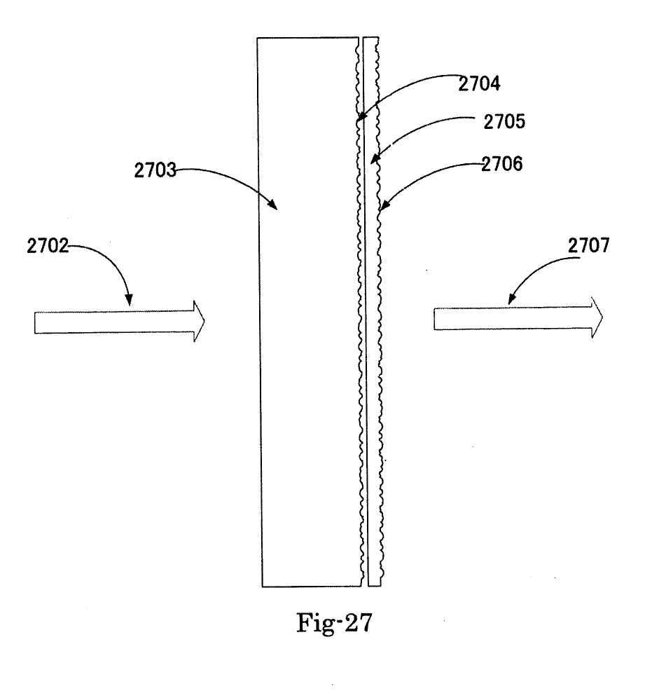

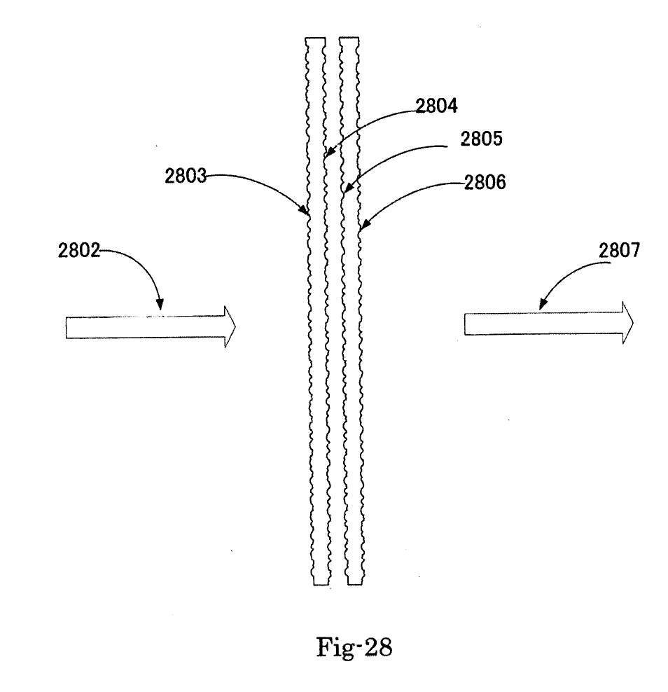

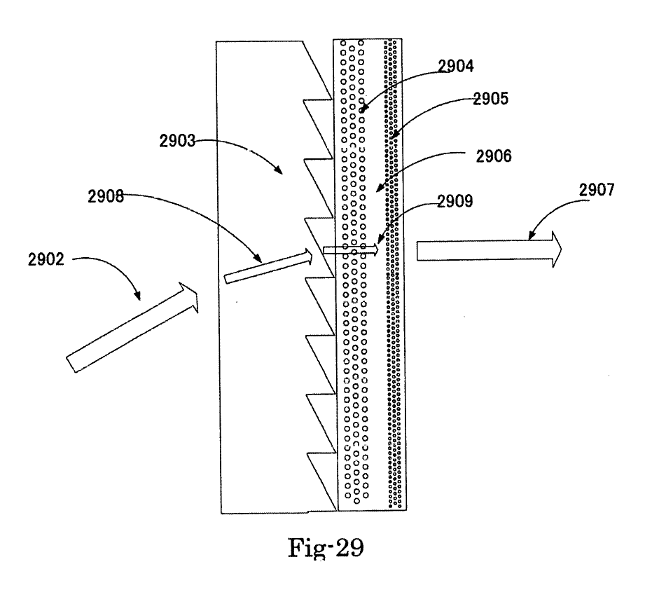

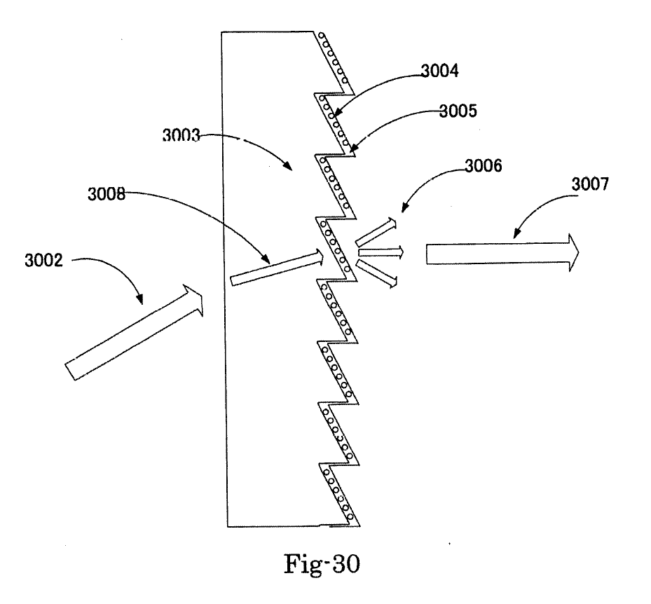

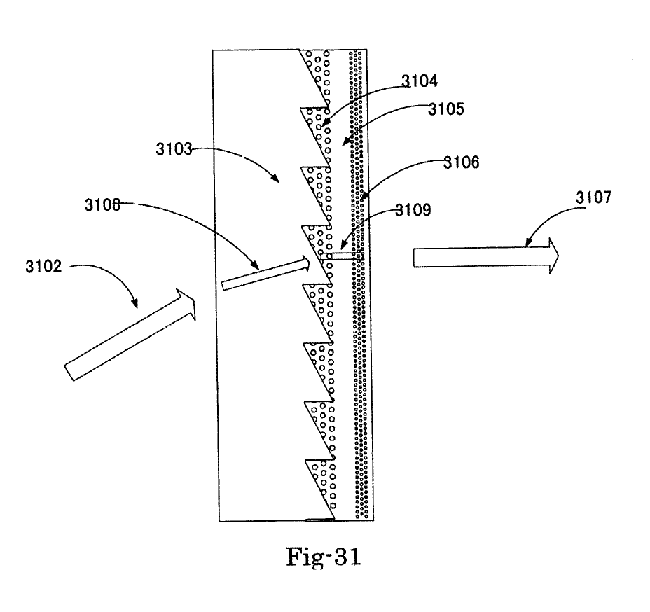

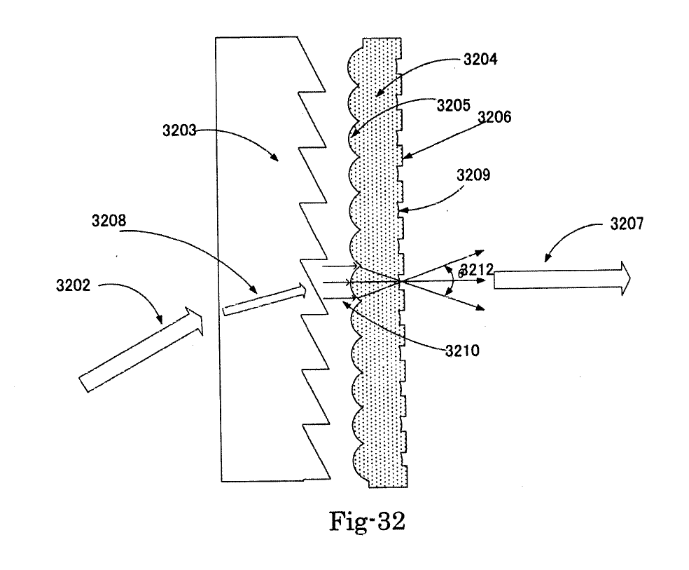

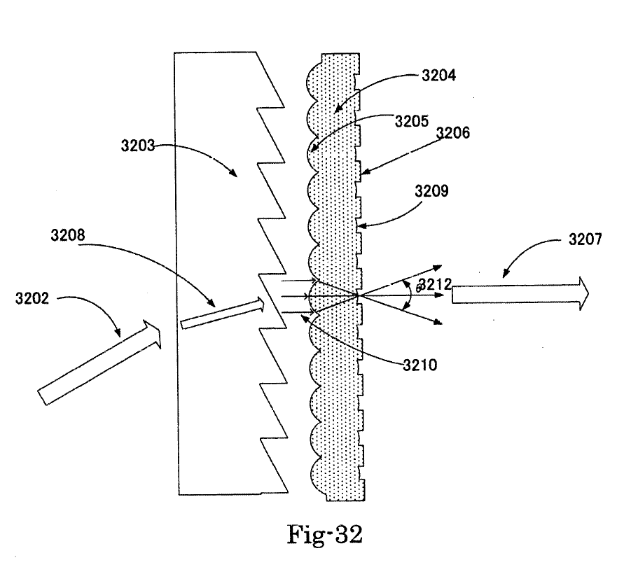

FIG. 32 shows an example of the embodiments of this invention of speckle reduction projection screen, wherein diffusion material is molded into a lenticular (3204). 3205 is an entrance lens. 3208 is an exit pupil. The area between two exit pupils (3206) is coated black to improve contrast. The angle θ (3212) is the apparent angle of diffused light. 3210 is collimated light by the Fresnel lens (3203).

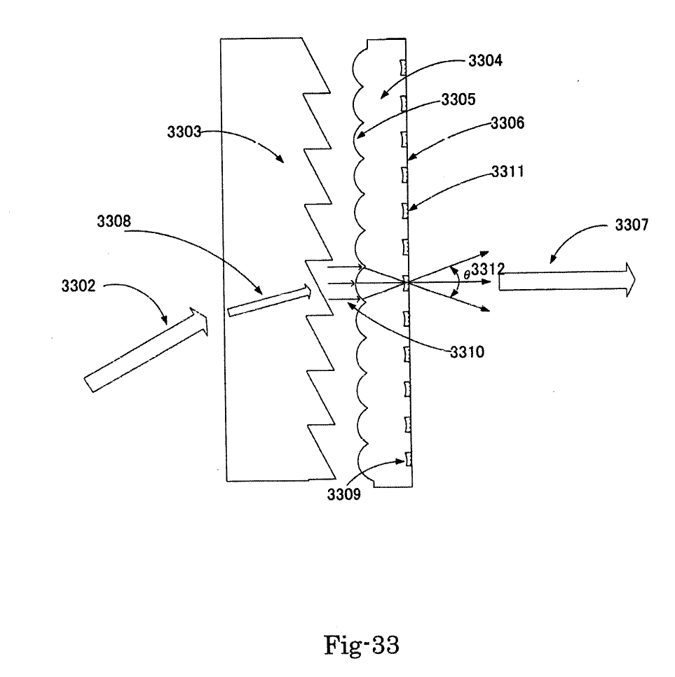

FIG. 33 shows an example of the embodiments of this invention of speckle reduction projection screen, wherein diffusion material is coated in the exit pupils (3309). 3305 is an entrance lens. 3311 is diffusion layers in an exit pupil (3309). The area between two exit pupils (3306) is coated black to improve contrast. The angle θ (3312) is the apparent angle of diffused light. 3310 is collimated light by the Fresnel lens (3303).

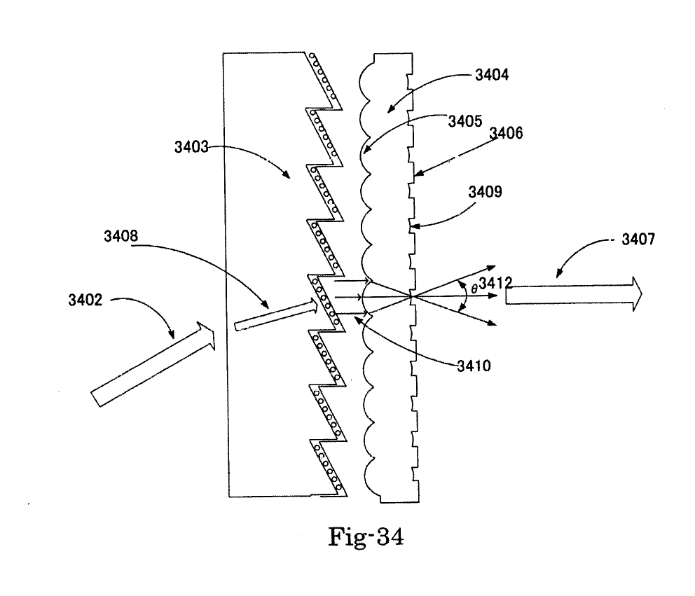

FIG. 34 shows an example of the embodiments of this invention of speckle reduction projection screen, wherein diffusion material is coated conformally over the grooves of Fresnel lens and combined with a lenticular. 34034 is the exit pupils. 3405 is an entrance lens. The area between two exit pupils (3406) is coated black to improve contrast. The angle θ (3412) is the apparent angle of diffused light. 3410 is collimated light by the Fresnel lens (3403).

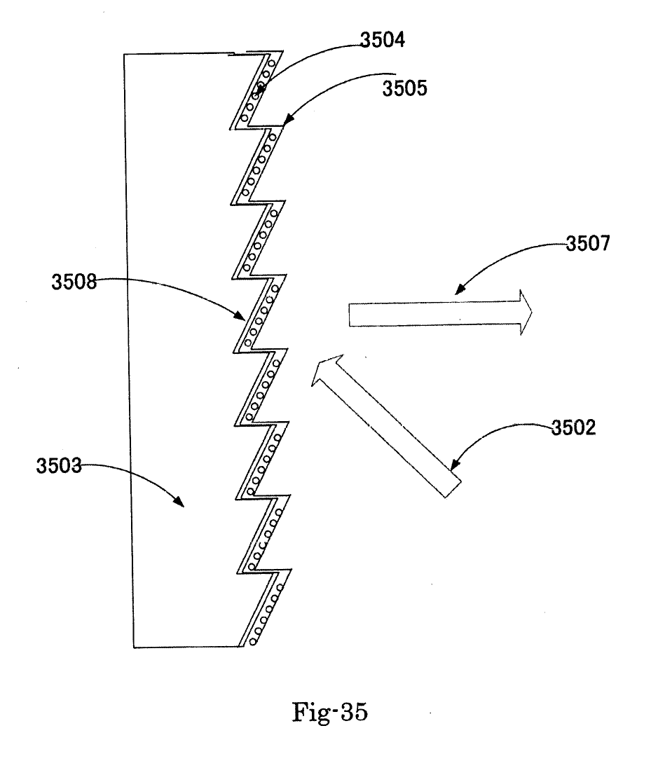

FIG. 35 shows an example of the embodiments of this invention of speckle reduction projection screen, wherein a reflective screen is made with a conformal coating of a diffusion layer over the grooves of Fresnel lens. 3503 is the substrate of Fresnel mirror. 3508 is a reflective layer to create mirror surface. 3504 is a diffusion layer with particles. 3505 is binder for diffusion material. 3502 is an incident light containing projection image. 3507 is the outgoing light toward viewers.

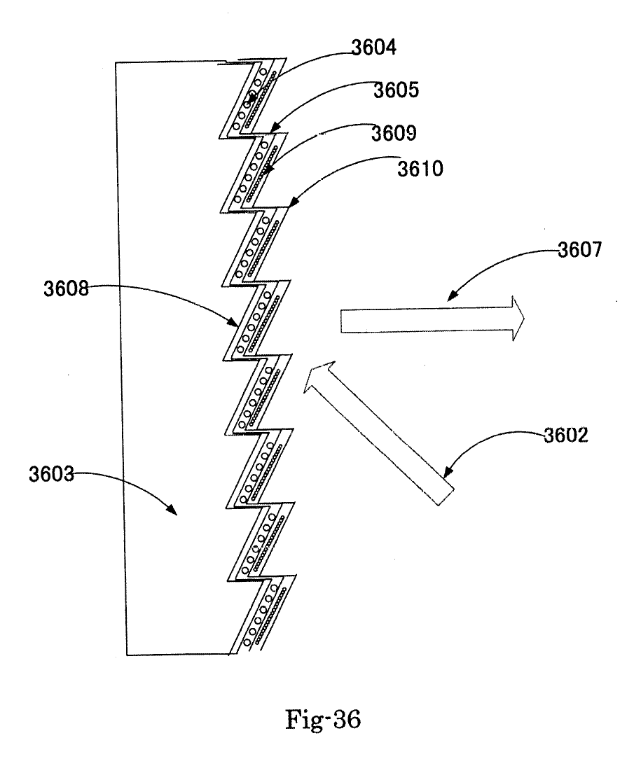

FIG. 36 shows an example of the embodiments of this invention of speckle reduction projection screen, wherein a reflective screen is made with conformal coating of two diffusion layers over the grooves of Fresnel lens. 3603 is the substrate of Fresnel mirror. 3608 is a reflective layer to create mirror surface. 3604 is a first diffusion layer with particles. 3605 is binder for diffusion material for the first layer. 3608 is a reflective layer to create mirror surface. 3609 is a second diffusion layer with different size of particles from those of the first layer. 3610 is binder for diffusion material for the second layer. 3602 is an incident light containing projection image. 3607 is the outgoing light toward viewers.

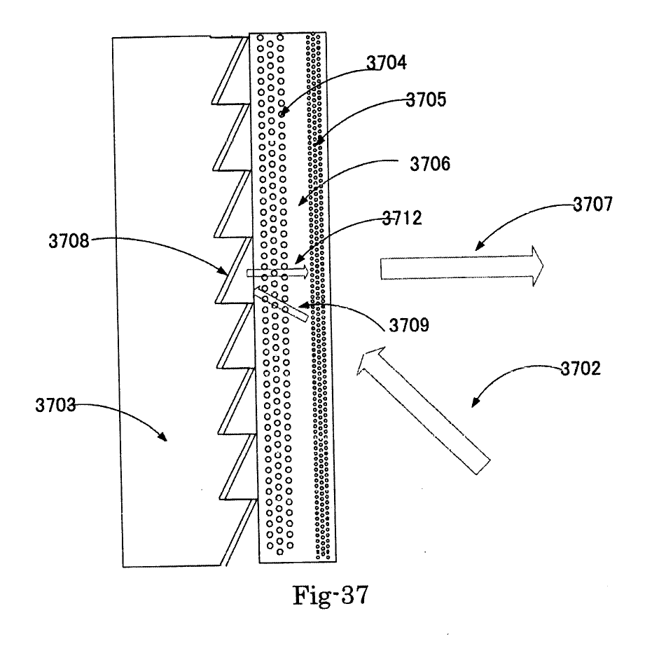

FIG. 37 shows an example of the embodiments of this invention of speckle reduction projection screen, wherein a reflective screen is made with conformal coating of a reflective layer over the grooves of Fresnel lens and a separate diffusion sheet with multi-diffusion layers. 3703 is the substrate of Fresnel mirror. 3708 is a reflective layer to create mirror surface. 3704 is a first diffusion layer with particles. 3706 is binder for diffusion material for the first layer. 3708 is a reflective layer to create mirror surface. 3705 is a second diffusion layer with different size of particles from those of the first layer. 3702 is an incident light containing projection image. 3712 is the collimated light by the Fresnel mirror (3708). 3707 is the outgoing light toward viewers.

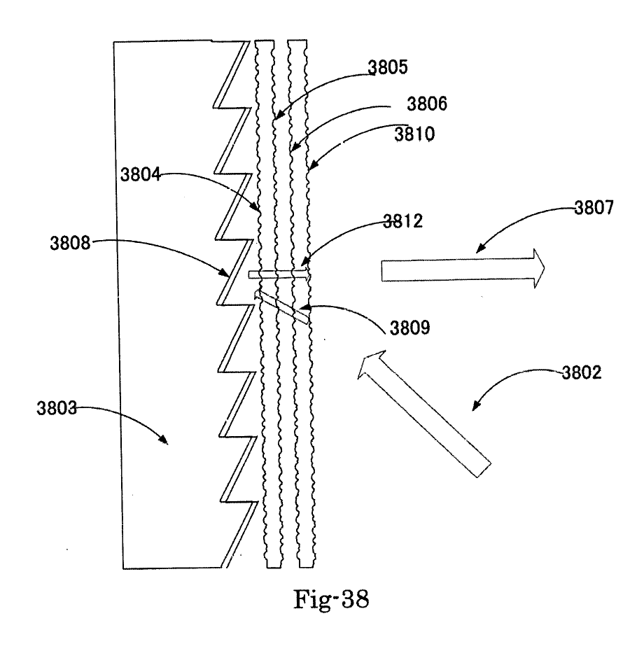

FIG. 38 shows an example of the embodiments of this invention of speckle reduction projection screen, wherein a reflective screen is made with conformal coating of a reflective layer over the grooves of Fresnel lens and a separate diffusion sheets with diffusive surfaces. 3803 is the substrate of Fresnel mirror. 3808 is a reflective layer to create mirror surface. 3804 is a first diffusion surface. 3805 is a second diffusion surface. 3806 is a third diffusion surface. 3810 is a fourth diffusion surface. 3802 is an incident light containing projection image. 3812 is the collimated light by the Fresnel mirror (3808). 3807 is the outgoing light toward viewers.

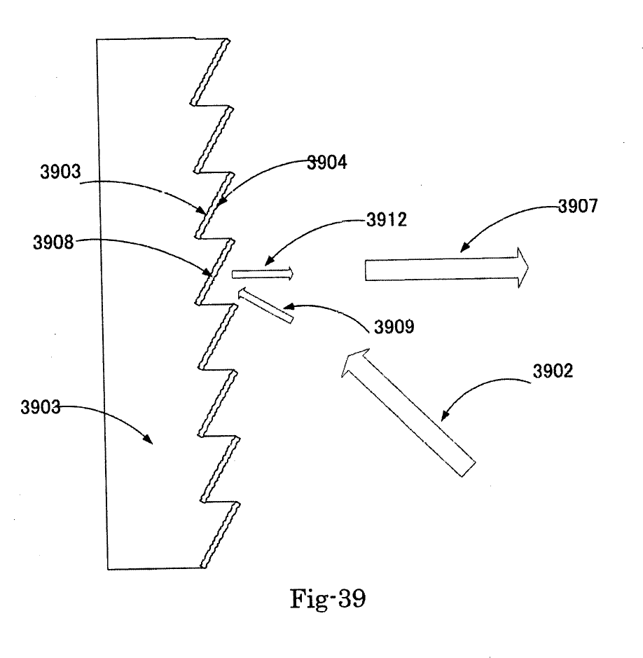

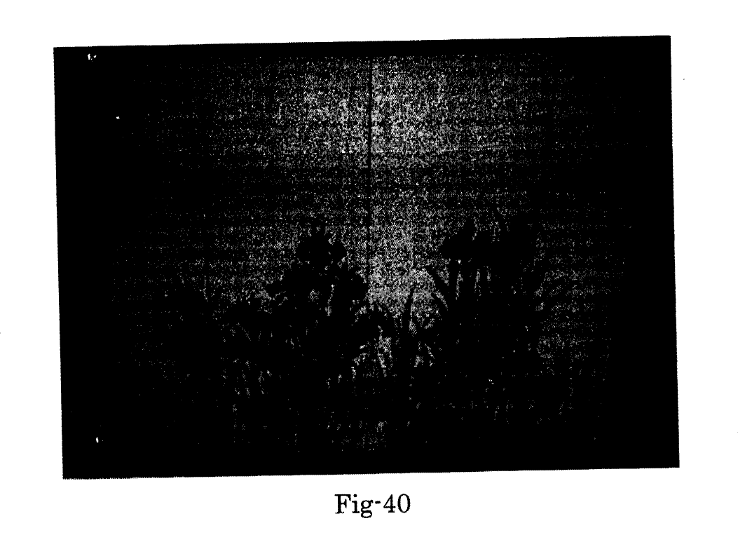

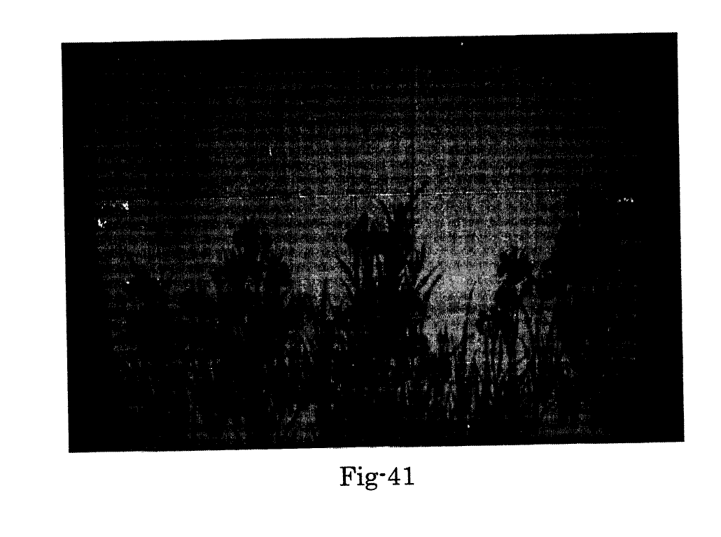

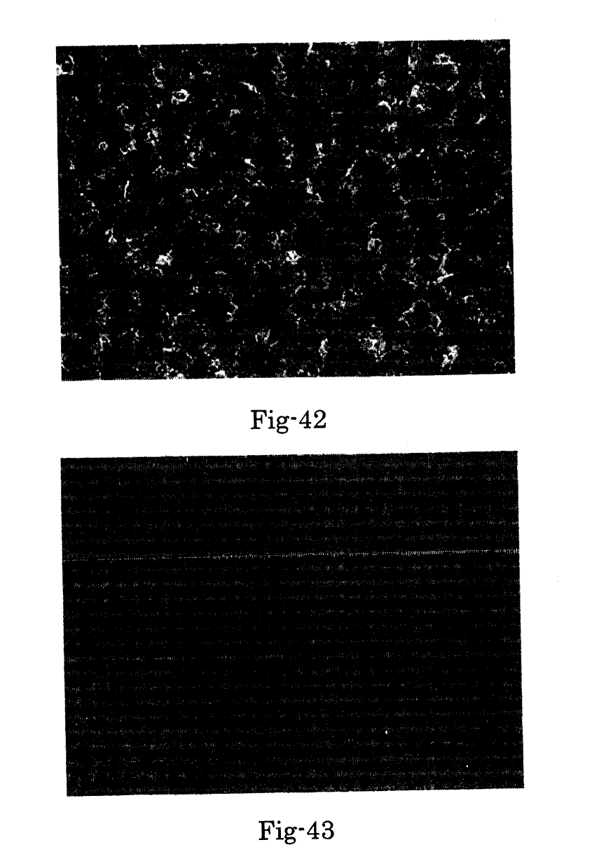

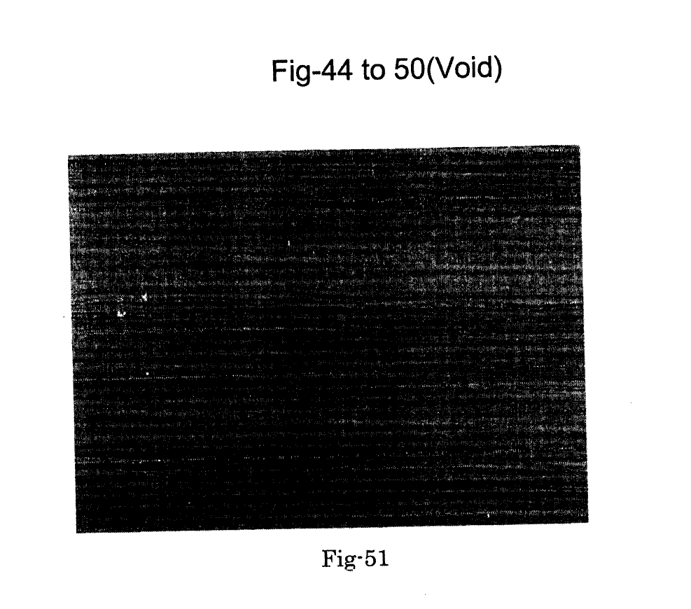

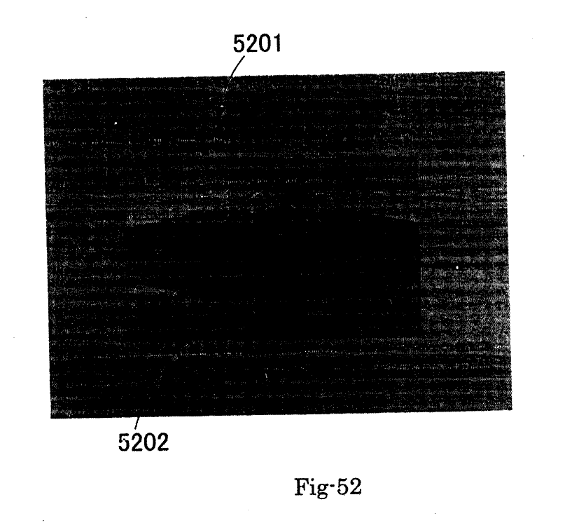

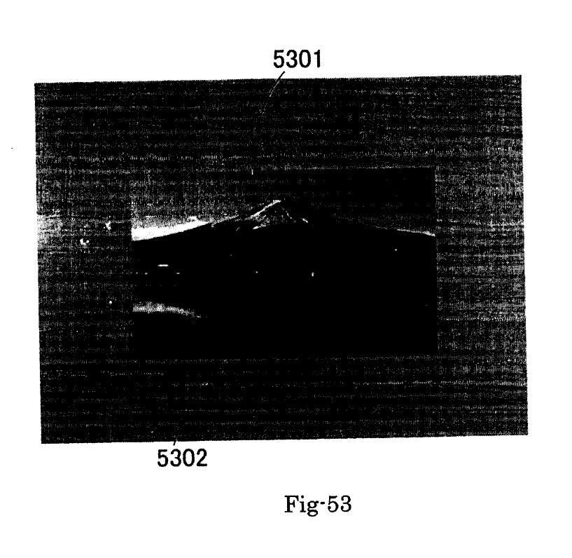

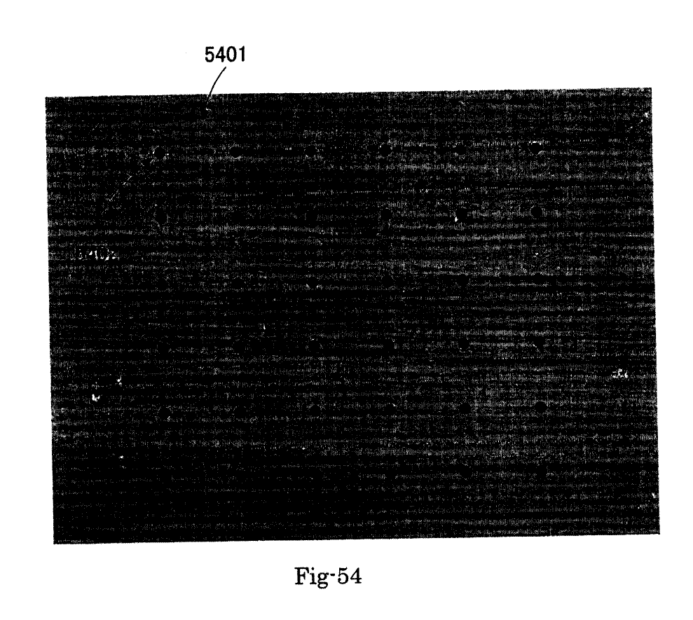

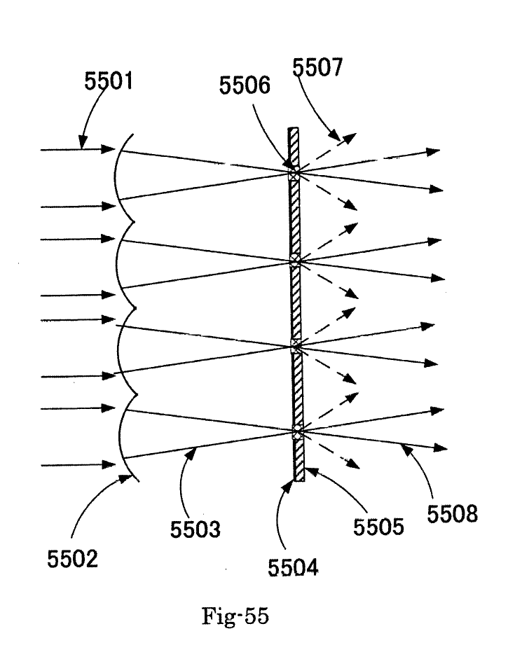

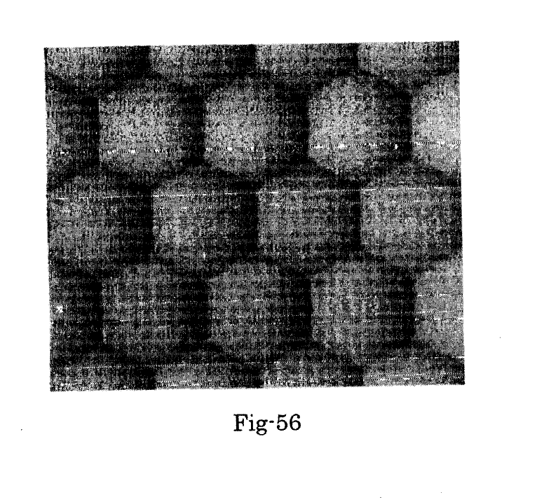

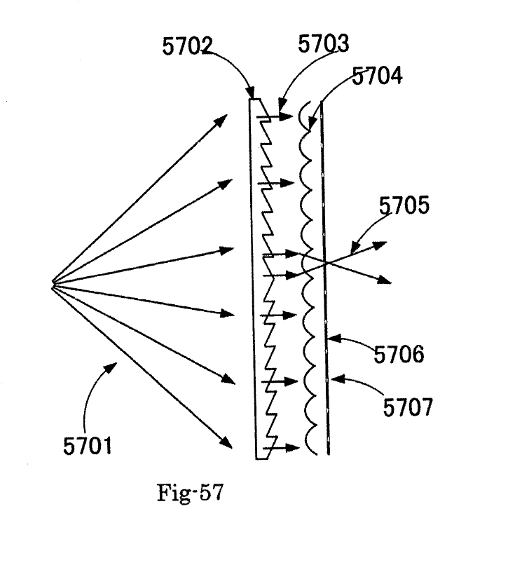

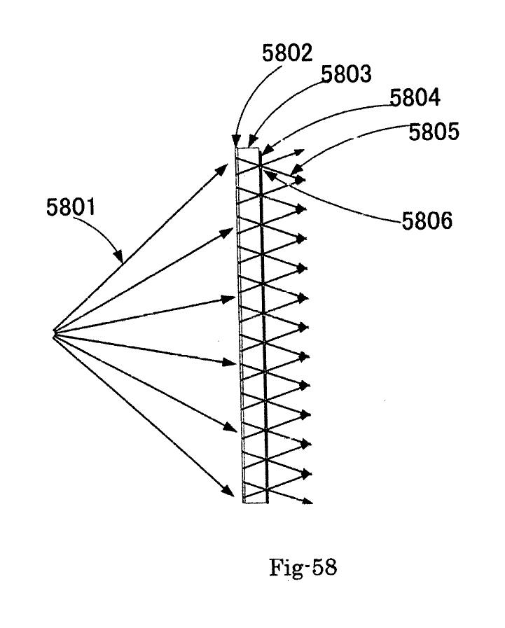

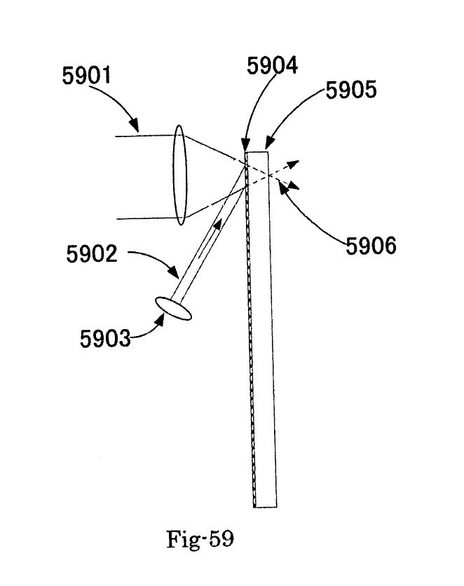

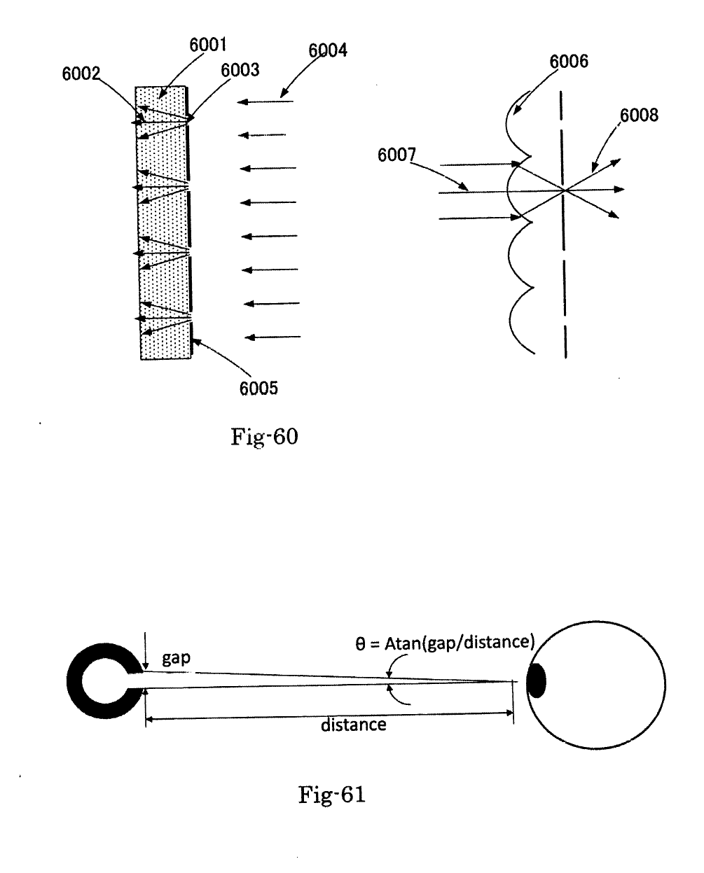

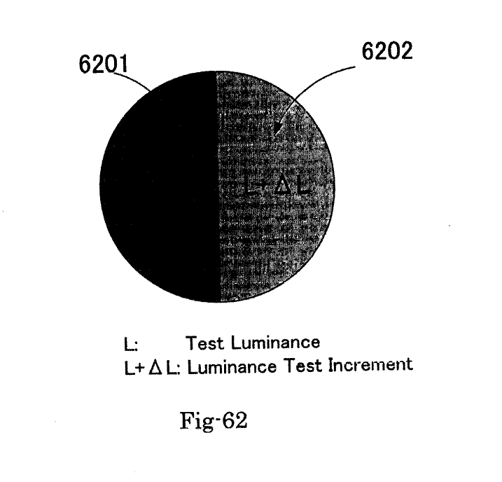

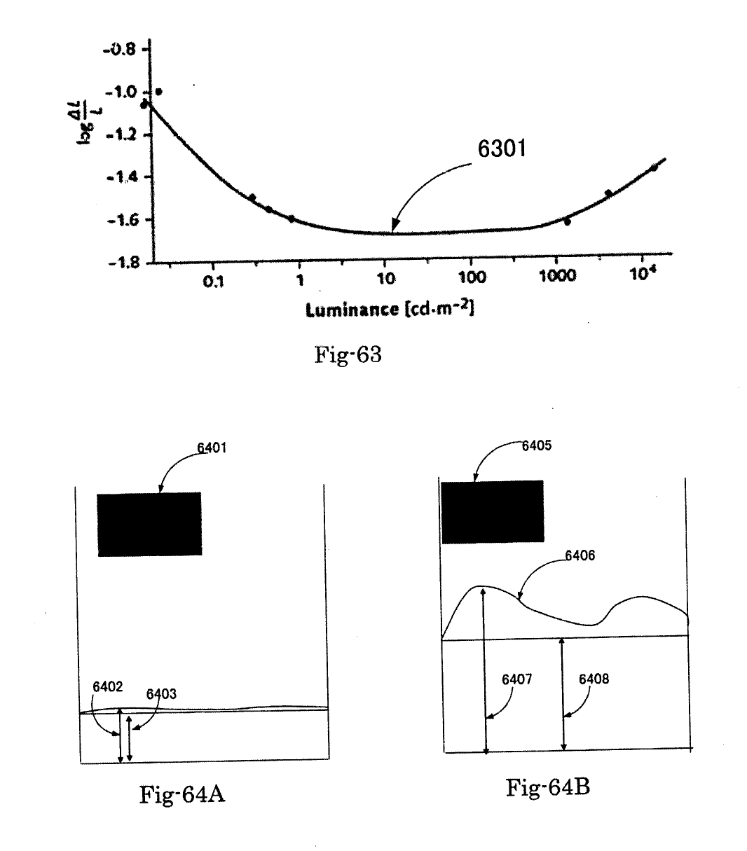

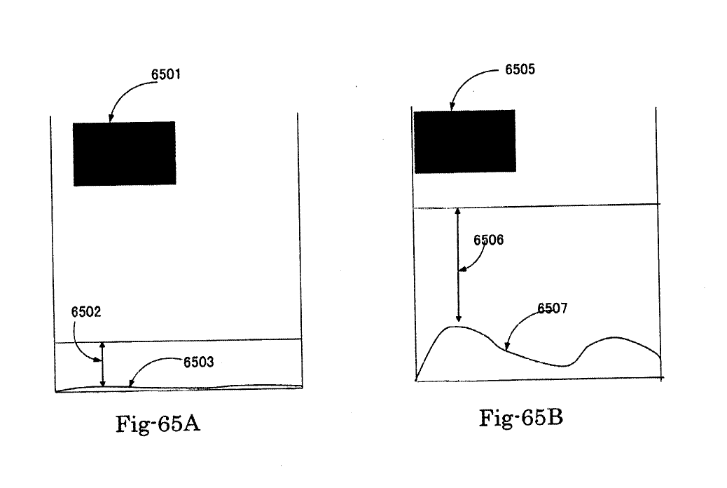

FIG. 39 shows an example of the embodiments of this invention of speckle reduction projection screen, wherein a reflective screen is made with conformal coating of a reflective layer over the rough surfaces of grooves of Fresnel lens. 3903 is the substrate of Fresnel mirror. 3908 is a reflective layer to create mirror surface. 3904 is a first diffusion surface which has rough surface so that the reflected light is scattered. 3912 is the collimated light by the Fresnel mirror (3908). 3907 is the outgoing light toward viewers.

FIG.-55 shows an example of the embodiments of this invention to create a decorative screen wherein an incident light (5501) is focused by micro-lens-array or lenticular (5502) onto holes or transparent spots (5506), so that the majority of the incident light will be outputted. As illustrated in FIG.-54, holes (5402) on the surface of decorative surface with woody texture (5401) are created and the diameter of holes must be small enough not to be visible for human eyes. As illustrated in FIG.-57, an image of projection display (5701) is projected to a collimation lens (5702, Fresnel lens in this case). The light from the projector is lead to a diffuser plate (5704, Micro-Lens-Array in this case) which concentrates the incoming light into holes and diffuses the light toward a viewer. When the display is turned off, a viewer with vision 1.0 (or 20/20) does not recognize holes if the diameter of holes is less than 75 microns at 50 cm distance from the surface. (The reason will be explained later). When the display is turned on, an image will be visible and the decorative surface will not be noticeable if the brightness of image is 50 times brighter than that of the decorative surface (explained later).

FIG.-58 shows an example of the embodiments of this invention to create a decorative screen wherein an incident light (5801) is collimated and focused to each hole (5806) by HOE or DOE (5802), which functions as both collimator and micro-lens-array. Instead of micro-lens-array, holographic optical element (HOE) can be used as a diffuser. An HOE can be created as illustrated in FIG.-59, where a reference beam (5903) is applied to a hologram plate (5904) and an object beam is applied as (5906) for recording of hologram. After recording and fixing the hologram, if a reference beam is applied in the exactly same way as recording, the beam is reflected to create a beam as the object beam (5906). Thus the hologram works as the micro-lens-array in the previous paragraph.

FIG.-60 shows an example of the embodiments of this invention showing a manufacturing method wherein a photo-resist layer is coated (6001) and a collimated light is projected from the other side through holes or transparent spots (6002) so that only the photo-resist in the area around the holes will be exposed and creates convex micro-lens array over the holes after the development of the photo-resist.

FIG.-61 shows an example of the measurement of human vision acuity. 1 minute ( 1/60 of 1 degree) of viewing angle corresponds to 1.0 eye-sight or 20/20 vision acuity. If a person can discriminate only 2 minutes of angle, the eye-sight is 0.5 (inverse of viewing angle in minute is the definition of eye-sight) or 20/40 of vision acuity. Based on these measurement, it can be stated that 75 micron diameter holes cannot be visible to normal human eyes at 50 cm distance. FIG.-62 shows a test pattern to measure the sensitivity of human eye to relative brightness. FIG.-63 shows a measurement result of human eye to relative brightness. Based on these measurements, It can be stated that human eyes cannot discriminate the difference of brightness in adjacent areas if the relative difference of the brightness is less than 2%.

FIG.-64A shows an example of video image at dark video signal without compensation.

FIG.-64B shows an example of video image at bright video signal without compensation.

FIG.-65A shows an example of this invention to hide a decorative pattern by compensating with video signal applying opposite brightness to the decorative pattern at a dark image.

FIG.-65B shows an example of this invention wherein to hide a decorative pattern by compensating with video signal applying opposite brightness to the decorative pattern at a bright image.

Another example of the embodiments of this invention is to provide a decorative screen with a touch screen so that viewers can input their intention to the system.

Another example of the embodiments of this invention is to provide a decorative screen with a WiFi capability so that viewers can communicate with a host system interactively.

I claim:

1. An optic system for projection display comprising:
An image generating device and
A set of laser light sources and
At least one diffractive optical element (DOE) wherein
Said DOE reflects the light beams from said image generating device at least a single color and control the directions of said reflected light beams in preprogramed directions by the locations of said beams.

2. The optic system of claim 1 wherein:
The image generating device is from a group of transmissive SLM (Spatial Light Modulator), reflective SLM and Laser-Beam-Scanner and DOE is from a group of Diffractive Optical Element and Holographic Optical Element.

3. The optic system of claim 1 wherein:
The direction of projection from projection display is substantially vertical and away from the normal direction of the screen.

4. The optic system of claim 1 wherein:
The zero order diffraction from said DOE is away from the main path of optical system so that zero order light will not affect the image using a method from a group of Fourier lens, off-centered DOE and tilted DOE.

5. A projection screen comprising
A Screen and
A set of frames having protrusions to hold screens at holes and
A set of arms which can bend and provide tension to the frames and the screen

6. The projection screen of claim 5 wherein:
The frames and arms are made of plastic.

7. The projection screen of claim 5 wherein:
The locations of arms are between the edge of frames and the point at one third of the frame.

8. A projection display system comprising
Laser light source having coherent light and
A set of projection lens and
An image generating device and
A projection screen,
wherein speckle is reduced after image is projected and enlarged for viewers by diffusing image light in multiple steps at said screen having at least one substrate and at least one diffusion layer on said substrate wherein each layer has a diffusion layer from a group of a diffusion layer containing diffusion particles having refractive index different from binder holding said diffusion particles and a diffusion layer with a surface having substantially random three dimensional structures.

9. The projection display system of claim 8 wherein:
The screen is transmissive and has two substrates with at least one diffusion surface with substantially random three dimensional structures.

10. The projection display system of claim 8 wherein:
The screen is transmissive and has a Fresnel lens to collimate incoming light and a separate substrate having multiple layers of diffusion from a group of diffusion surface and diffusion layer containing diffusion particles.

11. The projection display system of claim 8 wherein:
The screen is transmissive and has a Fresnel lens to collimate incoming light and said Fresnel lens is coated with multiple layers containing diffusion particles.

12. The projection display system of claim 8 wherein:
The screen is transmissive and has a Fresnel lens to collimate incoming light and a separate lenticular containing diffusion particles to reduce speckle.

13. The projection display system of claim 8 wherein:
The screen is transmissive and has a Fresnel lens to collimate incoming light and a separate lenticular whose exit pupil is coated with diffusion material containing diffusion particles.

14. The projection display system of claim 8 wherein:
The projection screen is reflective and comprising
A substrate having a reflective surface and
Said reflective surface is covered with multiple layers of diffusion material.

15. The projection display system of claim 8 wherein:
The projection screen is reflective and the reflective surface has substantially random three dimensional structures so that the surface diffuses the reflected light

16. A display system comprising:
An image projector and
A diffuser plate and
A projection screen having a decorative surface attached to the diffuser plate where are light passing holes in the decorative surface and projected light from the projector passes though the holes and the image projected from said projector is visible to a viewer

17. The display system of claim 16 wherein:
Said diffuser is a plate from a group of Micro-Lens-Array, Lenticular, Holographic Optical Element (HOE), Diffractive Optical Element (DOE), Smoked Glass, Smoked Plastic Film and Embossed film.

18. The display system of claim 16 wherein:
There is an optical element which collimates light from the image projector toward said diffuser and the optical element is a plate from a group of Fresnel lens, HOE, DOE, lens and mirror.

19. The display system of claim 16 wherein:
There are multiple layers of diffuser.

20. The display system of claim 16 wherein:
Light diffusing material is filled in the holes.

21. The display system of claim 16 wherein:
The distribution of brightness of projected image from the image projector is adjusted to make the image of reflected light from the decorative surface is less visible to a viewer.

22. The display system of claim 21 wherein:
There is at least one brightness sensor adjacent to the projection screen and the distribution of projected image is adjusted using the measured brightness to make the pattern of the decorative surface less visible.

23. The display system of claim 16 wherein:
Said holes are made by a method from a group of Laser Ablation, Etching, Sand Blast, Lift-off and Printing of decorative pattern with non-printing hole-shaped areas.

24. The display system of claim 23 wherein:
Said holes are made by a self-aligned mask wherein holes are exposed with collimated light through a micro-lens-array.

25. The display system of claim 16 wherein:
There is a light shielding layer except the holes so that the light from the image projector does not illuminate the decorative pattern to make the decorative pattern less visible.

26. The display system of claim 16 wherein
Viewers can communicate with a host system with a touch screen and WiFi.

27. The display system of claim 16 wherein
A photo-resist layer is coated behind a decorative layer and the photo-resist layer is exposed through the holes so that a self-aligned micro-lens-array is formed.

28. A laser light source comprising:
At least two laser diodes and
At least one DOE in front of said laser diodes and
Laser beams are focused into a single optical fiber to integrate multiple laser beams into a single optical fiber.
